(19) United States
(12) Patent Application Publication
(10) Pub. No.: US 2009/0063995 A1
(43) Pub. Date: Mar. 5, 2009

(54) Real Time Online Interaction Platform

(76) Inventors: Samuel Pierce Baron, Santa Cruz, CA (US); Tzik George Cohen, Santa Cruz, CA (US)

Correspondence Address: Ashok Tankha, 36 Greenleigh Drive, Sewell, NJ, 08080, US

(21) Appl. No.: 12/198,908

(22) Filed: Aug. 27, 2008

Related U.S. Application Data
(60) Provisional application No. 60/966,353, filed on Aug. 27, 2007.

(51) Int. Cl. G06F 3/00

(52) U.S. Cl. 715/753

(57) ABSTRACT

Disclosed herein is a computer implemented method and system for real time online interaction and social consumption of media by multiple users. A virtual interaction platform is provided for use by the users for the real time online interaction. A synchronous media layer is provided on the virtual interaction platform. An interaction layer comprising multiple interaction modes for enabling the users to engage in group interactions is provided on the virtual interaction platform. A reporting, archiving, and analysis layer is provided on the virtual interaction platform. Multimedia content is simulcasted for synchronous viewing by the users using the synchronous media layer. Group interactions among the users are enabled by the interaction layer using multiple interaction modes. A marketing layer is provided on the virtual interaction platform for targeting in-platform advertisements to the users. The simulcasted multimedia content is therefore consumed by the users while interacting using the interaction modes.

### CROSS REFERENCE TO RELATED APPLICATIONS

This application claims the benefit of provisional patent application number U.S. 60/966,353 titled “Real-Time Online Interaction Platform”, filed on Aug. 27, 2007 in the United States Patent and Trademark Office.

### BACKGROUND

This invention, in general, relates to social networking. More particularly, this invention relates to a method and system for real time interaction and social consumption of media by multiple users.

Most social network services enable users to interact with each other by providing electronic mail vendors, short message services, blog sites, etc. Currently, online communities enable a group of users to interact through discrete means such as chat rooms, email, etc. across various geographical boundaries. These communities enable different levels of interaction and participation among the members of a group. Group members may add comments or tags on a blog site, post messages on a message board, play computer games with online competitors, etc. The platforms provided by the social network services and virtual communities are limited to discrete message boards, chat services, etc. Although chat rooms provide a real time online communication means to the users, the users may not be able to effectively interact with others in one or more communication modalities while they are discretely browsing the internet, watching a video online, taking part in online seminars, etc.

Hence, there is a need for a computer implemented method and system that allows users to interact with each other while synchronously viewing live or recorded multimedia content from multiple sources.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein address the above stated need for allowing users to interact with each other while synchronously viewing live or recorded multimedia content from multiple sources.

A virtual interaction platform is provided for use by the users for the real time online interaction. The virtual interaction platform provides an interactive and participatory environment with multimedia serving as a common reference point. A synchronous media layer is provided on the virtual interaction platform. An interaction layer is provided on the virtual interaction platform. A reporting, archiving, and analysis (RAA) layer is provided on the virtual interaction platform for analyzing group behavior of the users. Multimedia content is simulcasted for synchronous viewing by the users using the synchronous media layer. The interaction layer enables group interactions among the users using multiple interaction modes. The interaction modes may be one or more of multiple configurable modalities. The configurable modalities may comprise chat messages, bubble messages, comment components, user icons, graphical user interface widgets, and interactable objects. A marketing layer is provided on the virtual interaction platform. The marketing layer targets in-platform advertisements to the users. The marketing layer enables in-platform advertisements, sponsorships, product placement, merchandising, etc. to be targeted to users.

Multiple virtual sessions are created during the simulcasting of the multimedia content for engaging the users in group interactions. Virtual social gestures may be created by the users in the virtual sessions using the interaction modes. The virtual social gestures may represent emotions, attitudes, and views of the users during the group interactions in the virtual sessions. The RAA layer analyzes the group behavior of the users in the virtual sessions based on the virtual social gestures. The group behavior may be displayed in a graphical format on the interaction layer.

A social networking layer may further be provided on the virtual interaction platform. The social networking layer creates a social network of the users using the analyzed group behavior. The social networking layer manages the following tasks: participants profile creation, determining relationships among participants, and establishing relationships between the users. The social networking layer provides asynchronous community features to the users.

An administrative layer may further be provided on the virtual interaction platform. The administrative layer provides tools and application programming interfaces for managing virtual sessions, customizing the virtual interaction platform, branding, marketing and merchandising, authenticating the users, and managing other layers of the virtual interaction platform. The administrative layer enables administrative management of the other layers in the virtual interaction platform, by platform partners and administrators. Further, the administrative layer enables management of the administrative accounts of platform partners of the virtual interaction platform, and user accounts, virtual sessions, marketing, captured session data, etc. The platform partners comprise partner websites, sponsoring partners, etc., of the virtual interaction platform. The administrative layer also provides an online administration console for managing the virtual interaction platform and monitoring the real time online interaction.

The interaction layer may also conduct real time polls among the users. The interaction layer further comprises a graphical user interface for graphically displaying the simulcasted multimedia content, the interaction modes, in-platform advertisements, user profiles, and group dynamics. The simulcasted multimedia content is therefore consumed by the users while interacting in real time using the interaction modes.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for real time online interaction and social consumption of media by multiple users.

FIG. 2 illustrates computer implemented system for real time online interaction and social consumption of media by multiple users.

FIG. 3 exemplarily illustrates a “miniprofile” window displaying a brief summary of information about the user.

FIG. 4 exemplarily illustrates a screen shot of a lobby view presented on a graphical user interface (GUI).

FIG. 5 exemplarily illustrates a screen shot of the graphical user interface presented by the synchronous media layer during a virtual session.

FIGS. 6A-6C exemplarily illustrate crowd visualization in the virtual session.

FIG. 7 exemplarily illustrates a screen shot of a user-directed video simulcast to users in a virtual session.

FIG. 8 exemplarily illustrates a screen shot of graduated interaction modes.

FIG. 9 exemplarily illustrates the interactable objects.

FIG. 10 exemplarily illustrates a screen shot of the grab scene feature for enabling a user to capture a video clip of the simulcast media.

FIG. 11 exemplarily illustrates stacking of the bubble messages on the graphical user interface.

FIGS. 12-13 exemplarily illustrate the dial testing component with the user operable slider for enabling gathering of response data to the multimedia content and other simulcasted media.

FIG. 14 exemplarily illustrates an online poll conducted among the users.

FIG. 15 exemplarily illustrates a playlist component for enabling queue display and control of content to be played or viewed in the virtual session.

FIG. 16 exemplarily illustrates a schedule comprising a series of defined events for the virtual session.

FIG. 17 exemplarily illustrates a list of users participating in a trend spotter game with scores.

FIGS. 18-27 illustrate the online administration console with different management interfaces.

FIG. 28 exemplarily illustrates a trivia quiz conducted among the users.

FIG. 29 exemplarily illustrates a screen shot of a trend spotter game played by the users.

### DETAILED DESCRIPTION OF THE INVENTION

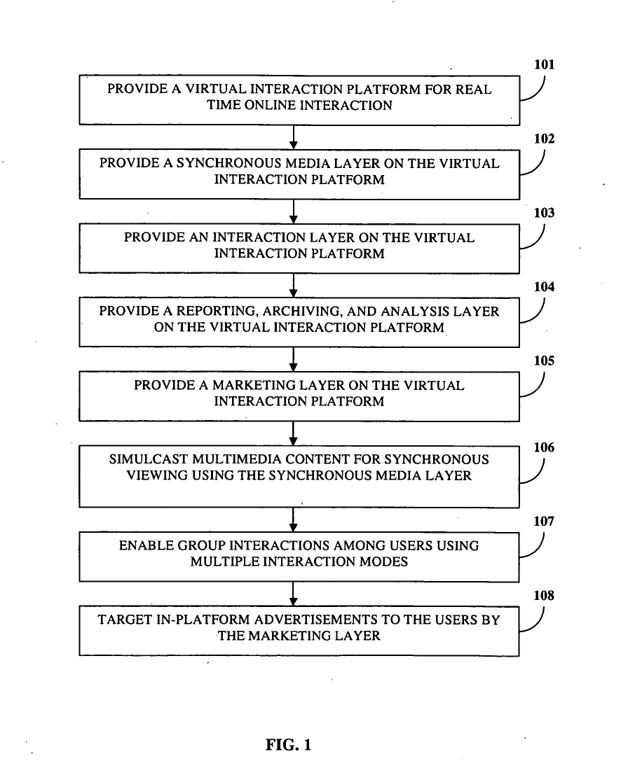

FIG. 1 illustrates a computer implemented method for enabling real time online interaction and social consumption of media by multiple users. A virtual interaction platform is provided 101 for use by the users for real time online interaction. A synchronous media layer is provided 102 on the virtual interaction platform for simulcasting multimedia content for synchronous viewing by the users. The synchronous media layer enables synchronous group viewing of live or recorded multimedia content from multiple sources. Multiple instances of media content may be displayed simultaneously. An interaction layer is provided 103 on the virtual interaction platform. The interaction layer provides configurable and componentized modalities for real time synchronous group interaction. A reporting, archiving and analysis (RAA) layer is provided 104 on the virtual interaction platform. The RAA layer analyzes group behavior of the users. A marketing layer is provided 105 on the virtual interaction platform. Multimedia content is simulcast 106 to the users for synchronous viewing using the synchronous layer.

The interaction layer enables 107 group interactions among the users using multiple interaction modes. Virtual sessions are created on the virtual interaction platform during the simulcasts for engaging the users in the group interactions. In the virtual sessions, the users interact with each other expressing views on the multimedia content being simulcast. The users may create virtual social gestures using the interaction modes. The virtual social gestures represent emotions, attitudes, views, and opinions of the users during the group interactions. The interaction modes are one or more of multiple configurable and componentized modalities and may comprise chat messages, bubble messages, comment components, user icons, graphical user interface (GUI) widgets, interactable objects, and graphical objects and animations. Real time polls may also be conducted among the users.

The RAA layer analyzes the group behavior of the users. The analysis of the group behavior may partly be based on the virtual social gestures created by the users during the interactions. Output of the analysis of group behavior is used for crowd visualization and for displaying group dynamics such as mood, alignment, etc. The group behavior or dynamics may be displayed in a graphical format on the interaction layer. A social networking layer may also be provided for creating a social network of the users using the analyzed group behavior. The virtual interaction platform provides an interactive and participatory environment with the simulcast multimedia content serving as a common reference point and catalyst for interaction.

In-platform advertisements, sponsorships, product placement, merchandising, etc. are targeted 108 to the users by the marketing layer. The in-platform advertisements may provide brand leadership in online entertainment for a sponsoring partner, retain users' attention, sell advertisements, gather market data, and boost content sales of featured multimedia content.

An administrative layer may be provided on the virtual interaction platform. The administrative layer provides tools and application programming interfaces for managing virtual sessions, customizing the virtual interaction platform, branding, marketing and merchandising, authenticating the users, and managing other layers of the virtual interaction platform. The administrative layer provides an online administration console for managing the virtual interaction platform and monitoring the real time online interaction. The RAA layer allows the administrators of the virtual interaction platform and the platform partners to export virtual session activity data and display analyses via the administrative layer. For each virtual session, the RAA layer archives virtual session content. The archived virtual session content comprises media and virtual session activity log, analyses of the virtual session activity, etc., for future uses, such as viewing and analysis. The archived virtual session content may be retrieved for replaying the virtual session. The archived virtual session content may further be used to resume an interrupted virtual session at a later point in time.

The administrative layer of the virtual interaction platform interacts with other layers of the virtual interaction platform to enable management of the virtual interaction platform by partners and administrators. The administrative layer manages the administrative accounts of the platform partners. The administrative layer provides administrative rights to the platform partners and administrators to manage virtual sessions, conduct polls, target advertisements, collect user information, manage user accounts, etc. The administrative layer provides tools and application programming interfaces (APIs) for managing the multimedia content, virtual sessions, single sign on (SSO), customization of the virtual interaction platform, branding, marketing and merchandising, user authentication, and managing other layers of the virtual interaction platform.

The multimedia content may be a live or recorded television program being broadcast on television. The virtual session activity such as polls, and users' comments, views, opinions, etc. may be fed back into the television broadcast to augment the broadcast content. In the case of a live television broadcast, the virtual session activity may be broadcast along with the live multimedia content. For example, a movie may be broadcast on television from television media feeds. Online virtual session activity such as polls and comments may be exported back into the television broadcast to augment the broadcast content. These poll activities and comments included in the television broadcast may be available for general viewing.

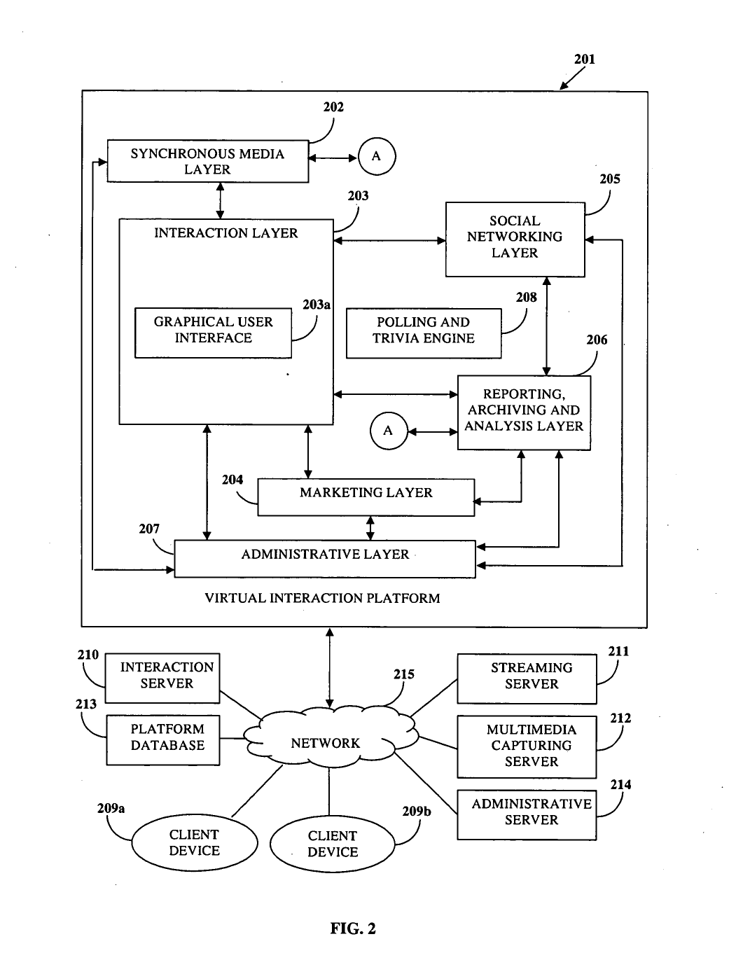

FIG. 2 exemplarily illustrates a computer implemented system for real time online interaction and social consumption of media by the users. The system disclosed herein comprises a virtual interaction platform 201, an interaction server 210, a streaming server 211, a multimedia capturing server 212, a platform database 213, and an administrative server 214 connected via a network 215. The virtual interaction platform 201 comprises a synchronous media layer 202, an interaction layer 203, an RAA layer 206, a marketing layer 204, an administrative layer 207, a polling and trivia engine 208.

The synchronous media layer 202 simulcasts multimedia content for synchronous viewing by the users. The synchronous media layer 202 enables synchronous group viewing of live or recorded content from multiple sources. The synchronous media layer 202 may utilize a streaming server 211 for simulcasting the multimedia content for synchronous viewing by the users. The streaming server 211 may publish synchronized video streams to the users. The streaming server 211 may further publish the synchronized video streams as an origin server to edge servers. The streaming server 211 may provide live or on demand Flash Video (FLV) file streaming and webcam content streaming for the virtual sessions. The streaming server 211 may further perform stream scheduling and stream management.

The interaction layer 203 comprises multiple interaction modes for enabling the users to engage in group interactions. The interaction modes may be one or more of multiple configurable modalities. The configurable modalities comprise chat messages, bubble messages, comment components, user icons, graphical user interface widgets, interactable objects, graphical objects, and animations. The configurable modalities may further comprise activity based initiation, graduated interaction modes, a polling and trivia mode, and a crowd visualization mode.

The interactable objects are animated images users may target or “throw” at the viewing screen or other areas of the GUI 203a, enabling direct interaction between the user and virtual session content. The interactable objects provide a mode of personal expression that maintains a degree of anonymity, enabling low-risk participation by the users. The interactable objects may comprise projectiles, for example, tomatoes, arrow, or darts or placed objects such as beating hearts, kisses, or pop-up text bubbles. The interactable objects may also comprise humorous onomatopoeia, for example, “KAPOW!”. When interactable objects are activated, the users in the session experience the interactable animation and sound in real time. The interactable objects may be customized for content or branding. The interactable objects are exemplarily illustrated in FIG. 9.

The interaction layer 203 enables creation of multiple virtual sessions during the simulcasting of the multimedia content on the virtual interaction platform 201 for engaging the users in the group interactions. The interaction layer 203 enables creation of the virtual social gestures by the users using the interaction modes. The virtual social gestures represent emotions, attitudes, and views of the users during the group interactions. The interaction layer 203 further enables displaying of group behavior analyzed by the RAA layer 206 based on the virtual social gestures in a graphical format.

The virtual social gestures are avatar actions to express emotions of the user about the virtual session content or about other users. For example, the virtual social gestures may express laughter, disapproval, celebration, or other emotions. The virtual social gestures may cause a user avatar move or change appearance, and may be accompanied by a sound. Virtual social gesture controls may be subtle and complex, with action and sound volume based both on the triggering of the gesture by the user and on contextual factors such as the number of users in the virtual session. For example, clicking the “LOL” button causes the user avatar to bounce and play a sound clip of recorded laughter. Repeatedly clicking the LOL button causes the user avatar to bounce higher and laugh louder. Similarly, the larger the virtual session user group, the quieter one user's recorded laughter is played, to mimic the relative loudness of an individual in a group. The virtual social gestures may be interactive with other users, for example, “high fiving” a user, and may be branded.

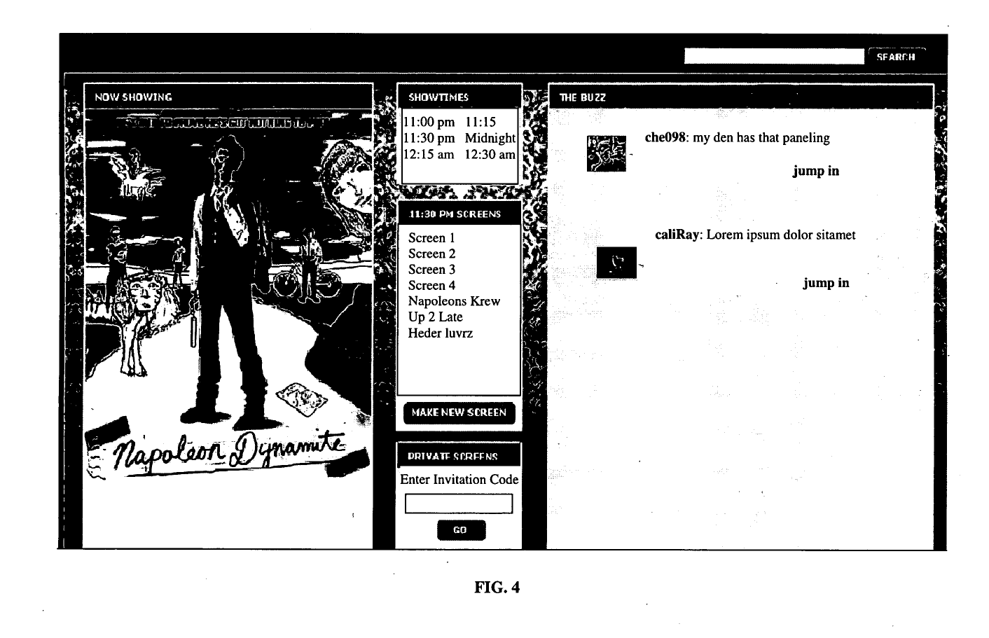

In activity based initiation, the users may choose virtual sessions. The objective of activity based initiation is to guide the right people into the same virtual session at the same time, based on the users' real time activity. A user may select a particular virtual session from multiple virtual sessions. The activity based initiation that assists the user in choosing a particular virtual session is exemplarily illustrated in FIG. 4.

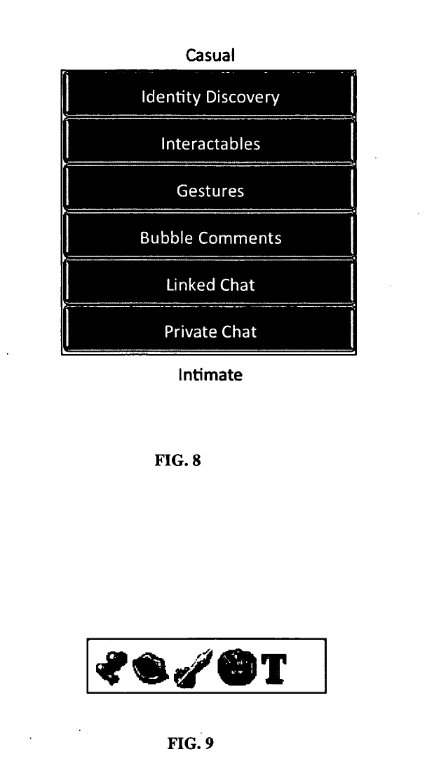

Some users may be disinclined to participate in a public session with strangers and expressing opinions in an online environment, even among friends. In graduated interaction modes, interaction modes are provided for the users to interact with each other at a level comfortable to the users. A suite of low-risk interaction modes is provided to make participation in the virtual sessions and discussions fun and safe. The users may voice opinions and learn about other users who may start out complete strangers. Each of the graduated interaction modes provides a specific level of safety and intimacy, allowing the users to escalate interaction with other users based on the user's the comfort level of the users. The interaction modes provide an engaging, social, and highly interactive, participatory environment. The interactable objects may, for example, comprise graphical objects such as thought, speech, cartoon bubbles, projectiles, etc. The least intimate interaction mode is identity discovery, in which the users learn about other users by examining available information and profiles. A screen shot of the graduated interaction modes are exemplarily illustrated in FIG. 8.

The interaction layer 203 may provide a user presence component for displaying the users currently participating in a virtual session and provides options for further discovery of the users and interaction with the users. Each user is represented by a flexible user avatar that may be static, animated, or a live video feed from a user's webcam. The flexibility of the user avatar enables the users to express their identities in multiple ways. The flexibility of the user avatar also enables the user presence component to support a wide range of applications for creating the user avatar.

The user presence component offers multiple layout options for groups of user avatars. For example, user avatars may be stacked into rows or shrink in size as size of the group grows. Each user avatar supports a pop-up rollover menu that may be configured to display username, basic user information, for example, age, gender, location, a larger-format or interactive avatar, a link to a user profile, a personal ringtone, moderation controls, for example, “block”, “eject”, “make moderator”, etc, social networking controls, for example, “add friend”, “gift” etc, or communication controls, for example, “chat”, “message”, etc. The personal ringtone enables a user to assign an audio clip to the user profile as a way to quickly express individuality via music, voice, or other sounds. Other users may access the ringtone to find out about each user with minimal effort.

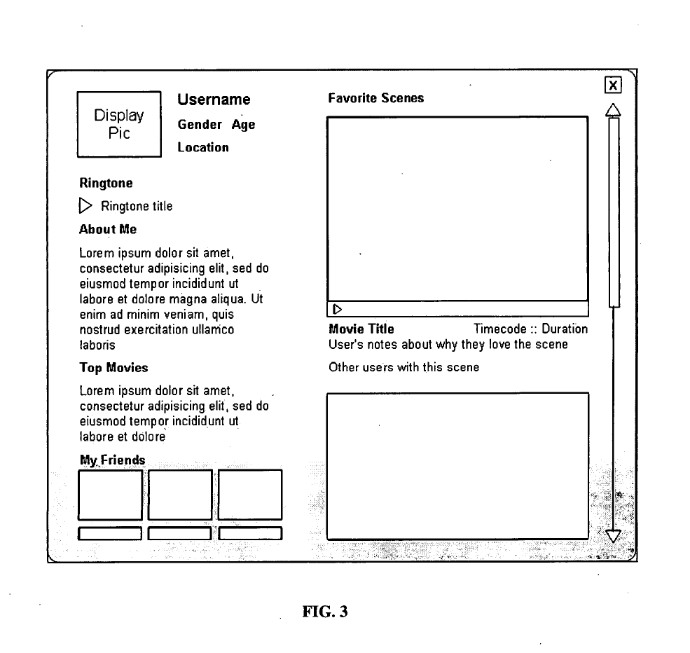

A user may access information about other users via a “miniprofile”. A miniprofile of a user may refer to a brief summary comprising information about the user. Miniprofile information is managed from the user's account manager. Alternatively, the miniprofile can be replaced with a redirect to a partner social network service's (SNS) user profile. FIG. 3 exemplarily illustrates a miniprofile window displaying a brief summary of information about the user. The miniprofile is displayed as part of the GUI 203a or as hyper text markup language (HTML) in a browser pop up window. The miniprofile is a simple user profile that is accessible without leaving the session environment. The profile may be automatically augmented with a history of the user's activity, for example, virtual sessions attended, captured scenes, top comments, and trivia scores. The miniprofile provides standalone light social networking. The miniprofile may also present user information from a user's existing social network. The miniprofile may also be disabled by the user and be replaced by a direct link to an existing user profile page. The interaction layer 203 may utilize an interaction server 210 for enabling the users to engage in the group interactions.

A client application resides on each of the client devices 209a and 209b of the users. The client application is used to connect the client devices 209a and 209b to a network 215 and enables the users to join the virtual sessions. The interaction layer 203 comprises a GUI 203a for graphically displaying the simulcasted multimedia content, the interaction modes, in-platform advertisements, user profiles, and group dynamics, within a single window or in multiple windows. FIG. 2 illustrates several client devices 209a and 209b accessing the virtual interaction platform 201 through the network 215, where appropriate, the multimedia content, user interactions, and other GUI 203a elements are synchronized between client instances.

The GUI 203a may comprise a video window component. The video window component allows application business rules or a live producer to change number, size, and layout of video windows and the content of the video windows in minimal time. Individual video windows may be provided with or without playback controls, for example, play, pause, seek, etc. The playback controls may be provided to all users or according to only to specific users, for example, a moderator. The video window layout may change with the virtual session content. For example, if a second presenter joins a first presenter in a live video virtual session simulcast, the video window may automatically resize itself to accommodate the second presenter. Onscreen titles may be pre-configured or produced live. The video component may detect bandwidth available to each user to provide the multimedia content in the highest bit rate that the client's internet connection supports without buffering or pausing.

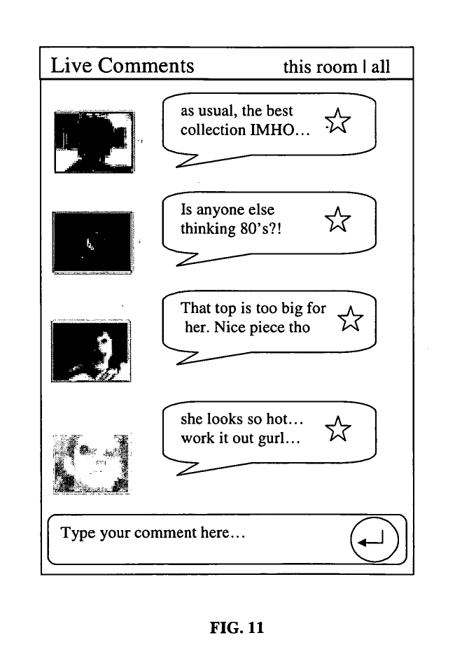

The GUI 203a may display simulcast multimedia content in an aspect ratio without dead space above and below the displayed multimedia content. The users post comments using the configurable modalities such as commenting components presented on the GUI 203a by the interaction layer 203. The commenting components may be chat messages, bubble messages, etc. For example, the bubble messages may appear to be stacked on the GUI 203a of the interaction layer 203, as exemplarily illustrated in FIG. 11. Subsequent bubble messages do not obscure any of the previous bubble messages. Old bubble messages may fade out to keep the comments current and make room for new bubble messages on the GUI 203a. Exemplarily, the users may communicate with each other in the virtual session using linked chat messages. A linked chat begins when a user links to a bubble comment before it fades in order to post a linked reply in real time.

The bubble messages appear as text in speech bubbles that pop out of users' avatars. The bubble messages are placed randomly about an area of the GUI 203a, appearing and then fading away after a short period. Unlike a standard text chat box, which is structured for direct user-to-user interaction and therefore intimidating, the undirected and temporary bubble messages comments enables the users to express a thought without expecting or requiring a response. The user may voice opinions about the virtual session content without being obligated to converse with other users. The bubble messages may also be stacked up vertically and may fade away with time.

The bubble messages may be configured to offer a link enabling others users to start a public chat based on the bubble message. The public chat, referred to as a “linked chat”, turns a bubble message into public chat window. The user sending the first bubble message may leave the linked by waiting a few seconds for the first bubble message comment to fade away. Any number of users may participate in a linked chat, and any number of linked chats may take place simultaneously on the GUI 203a. The linked chats may be cancelled or exited by the users. The linked chat windows fade out more slowly than bubble messages.

The users may also participate in private chats for direct and private communication. Private chats are the most intimate form of user interaction. The interaction layer 203 provides full-featured instant messaging for the private chats, with invitation options, multiple independent chat windows, and emoticons. The private chats may be easily integrated with other components to enable invitation via the user avatar rollover menu.

The bubble messages may also be configured to include a link for marking a bubble message as a favorite. An associated number displays the number of times the bubble message has been marked as a favorite. A user may gain points, status, and recognition based on the number of the user's comments marked as a favorite by other users.

Rolling an on screen pointer over a user icon on the GUI 203a may display basic profile information of a particular user and menu options. For example, the menu options on the user icon may include options to add the user as a friend, block the user in the virtual session by hiding the activities from the user, open a message window and invite the user to chat or message, play an audio clip, etc. Users may chat with each other privately via the instant messenger of the virtual interaction platform 201. For example, to initiate a chat with another user in a virtual session, a user rolls over the user icon and clicks “Chat”. A chat or messenger service window is displayed to the user. The user initiating the chat types a message and clicks “Send”, which opens up a chat or messenger window on the GUI 203a of the recipient user. The chat or messenger activity may also be initiated from the friends list in the user profile.

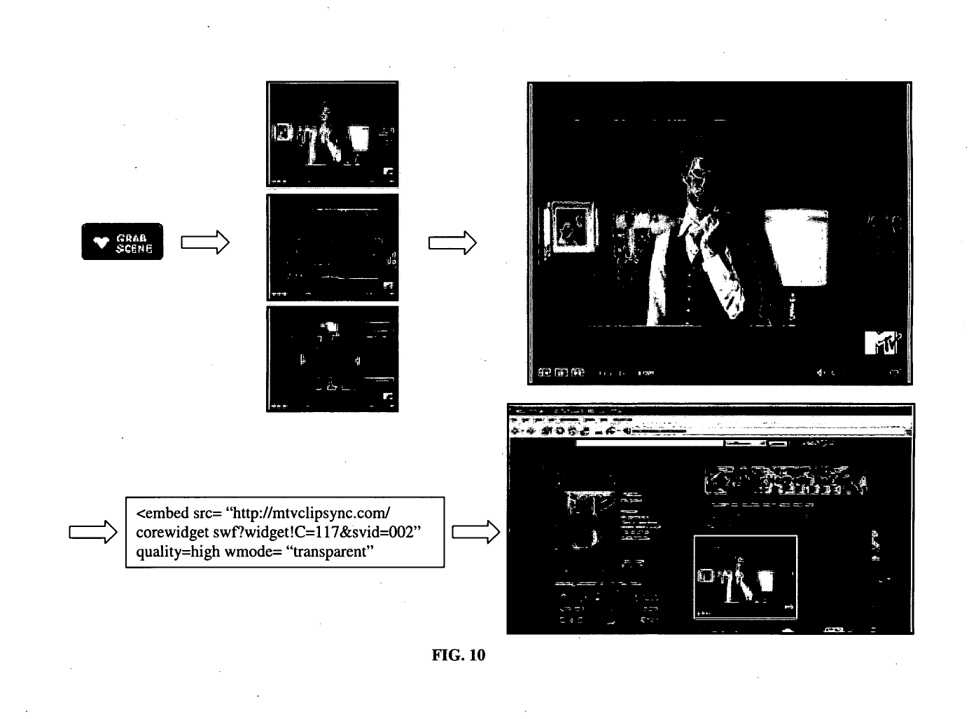

The users may also be able to capture user defined portions of the simulcasted multimedia content. The multimedia capturing server 212 may enable the users to capture user defined portions of the simulcasted multimedia content. For example, the user may be provided a “grab scene” feature that enables the user to capture a video clip of the simulcast media and save the video clip to the user's profile for viewing or for embedding within a branded player on external web pages. For example, the user clicks the “Grab Scene” button to start capture of the current multimedia content from a point in the content 5 seconds prior to the button click. The capturing continues until the user releases the button. A maximum capture time may be set for each piece of the multimedia content, for example, 30 seconds. The captured clip is saved to the user's clip list and made available for viewing in a user profile. Each clip may feature an embed code for posting the clip in a branded video player on external web pages. A screen shot of the grab scene feature for enabling the user to capture a video clip of the simulcast media is illustrated in FIG. 10.

A user may enter a virtual session as a guest. The guest may view the simulcast multimedia and the interactions between other in-session users. However, when the guest attempts to use the interaction modes such as comment, chat, grab scene, trivia, etc., the guest is prompted to login to the virtual interaction platform 201.

User controls provided on the GUI 203a comprise information and links related to logging the user in, for example, “username”, “link to sign out”, “link to profile”, etc. Other links and controls comprise an “invite” link to invite other users to a virtual session, a “jump to” control that displays a drop down list of other ongoing virtual sessions and enables a user to exit current virtual session and enter another virtual session. A “go to lobby” control allows a user to exit the current virtual session and return to a lobby view.

When new entrants access the virtual interaction platform 201, they are presented with a lobby view of multiple virtual sessions. Each simulcast multimedia, for example, each movie, may comprise a lobby view displayed on the GUI 203a. The lobby view provides information on the multimedia content, simulcast schedules or show times. The lobby view may display the schedules for upcoming and in progress public simulcasts. A user may select a simulcast schedule to display the reserved or created virtual sessions for the particular simulcast. Users may add virtual sessions to any active simulcast show time by pressing the “Make New Screen” button. A screen shot of the lobby view presented on the GUI 203a is exemplarily illustrated in FIG. 4.

The lobby view may comprise a “buzz” feature. The buzz feature provides a birds-eye view of the comments and other activity across multiple virtual sessions, filtered by schedules or show times, geography, etc. The buzz feature is an example of activity based initiation. In order to aid the users in virtual session selection, the buzz feature may present the users with activities in different virtual sessions that may be interesting to the users. The buzz feature may include the activities of the virtual sessions in progress. Alternatively, the activity list may be filtered by simulcast multimedia content, show time, virtual session, friends list, etc. before being presented to the user by the buzz feature.

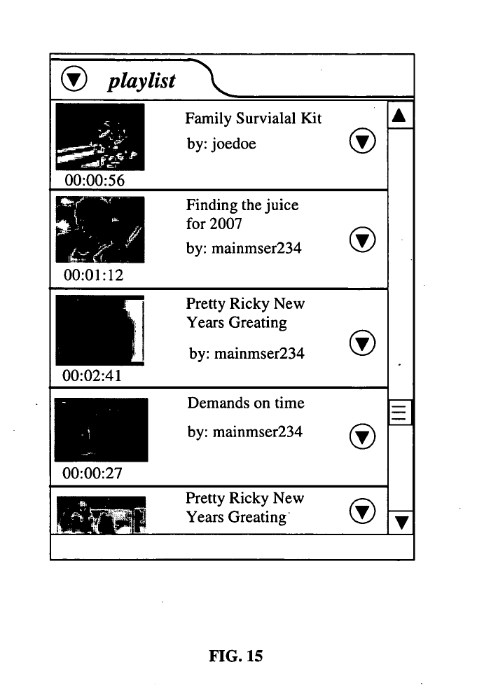

The lobby view may comprise a playlist component for enabling queue display and control of multimedia content to be played or viewed in the virtual session. The playlist may be preset with fixed content or set to allow one or more users to add, remove, manage, and navigate content during the virtual session. Playlist permissions may be managed centrally as part of user permissions. The playlist component is exemplarily illustrated in FIG. 15.

Host controls are provided to designated users or to a host user. The host user refers to a user who creates a virtual session. The host user is identified to others by a special user icon. The host user may silence a user in a virtual session for a specified or open-ended period of time. The host user may eject a user permanently from the virtual session and bar the ejected user from re-entry. The host user may further send a system message to a user as a warning.

While a virtual session is active, the host user may also lock and unlock the virtual session, for preventing or allowing entry of other users, add or remove users from the list, and shut down the virtual session, returning users in the virtual session to the lobby view.

A user may add a virtual session by pressing the “Make New Screen” button. The user is presented with a form where the user may select virtual session times, specify whether the virtual session is public or private, etc. The user may also send invitations to a list of friends or send announcements to friends containing information about the added virtual session. The user's account manager may display a list of upcoming virtual sessions the user has created or has been invited to.

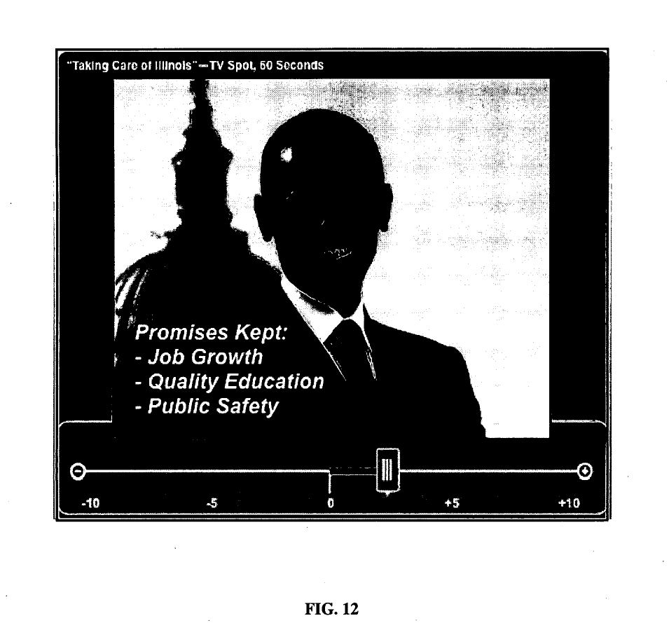

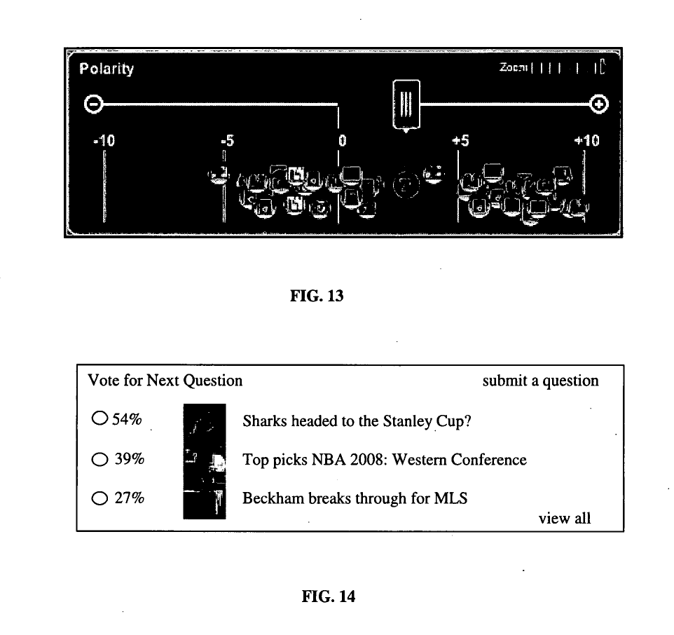

The interaction layer 203 may comprise a dial testing component to enable gathering of response data to the simulcasted multimedia content and other simulcasted media. Rather than gathering a small study group in a physical location, the dial testing component can gather testing feedback from thousands of users quickly and at low cost. The dial testing component comprises a user operable slider that resets to center quickly if the slider is released. The dial testing data is archived with time codes. The dial testing component with the user operable slider is exemplarily illustrated in FIGS. 12-13.

The synchronous media layer 202 and the interaction layer 203 may be tightly coupled to allow the interaction layer 203 to control the synchronous media layer 202, extending the range of interactive features. Clickable “hotspots” may be placed at specific points in the media time coded over specific areas of the media presentation. By clicking a hotspot, a user may control media playback, for example, to jump to another scene, select another piece of the multimedia content, or engage in a different group game or activity.

The polling and trivia engine 208 conducts real time polls among the users. The polling and trivia engine 208 enables the polling and trivia mode. The polling and trivia mode allows users, platform partners, and administrators of the virtual interaction platform 201 to author questions that may be presented to the users during the virtual sessions.

The polling and trivia engine 208 may be used to conduct online polls and quizzes. The polling and trivia engine 208 has a provision to suitably time the submission of poll questions according to the streaming multimedia content. The polling logic is set based on user responses such that contextual questions are provided to the users as a poll. The flexibility of the polling logic aids in the delivery of poll questions consistent with a user's interests and following branching lines of inquiry established by an author of the poll. The poll questions may be generally or specifically associated with sponsorship or advertising from third party agencies. Specific parameters of the user's activities, for example, frequency of the user's comments, ratings of the user's comments, and frequency of response by the user are captured to compute the user's interest level to the user's activities during a virtual session. An online poll conducted among the users is exemplarily illustrated in FIG. 14.

The polling and trivia engine 208 enables the system administrators, platform partners, and users to author questions. An authoring interface provides a series of question templates such as multiple choice, multiple selection, ranking, and essay type questions. A question may be selected by a platform partner to appear during a show time by first adding the question to a pool. The pool is then assigned to a show time or assigned to all show times for a particular movie. Individual questions may be added to multiple pools. Individual pools may be assigned to multiple show times and multiple movies.

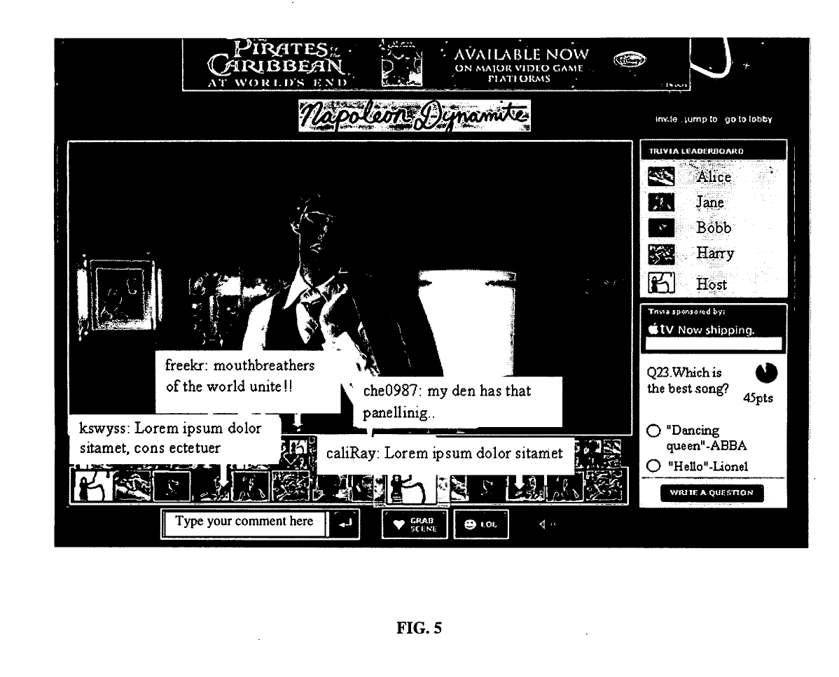

Once a pool has been assigned to a show time or a movie, multiple properties may be set. The properties may include the order of displaying the questions, specific times during the virtual session when the questions are displayed, display sponsor messages or advertisement images by individual question or by pool, etc. Scores may be awarded to the users for answering the questions. The scoring may be based on the timing of the answer submitted by the user. The awarded scores may be tracked by the user during the virtual session. The GUI 203a may display a leader board component during the virtual session as illustrated in FIG. 5.

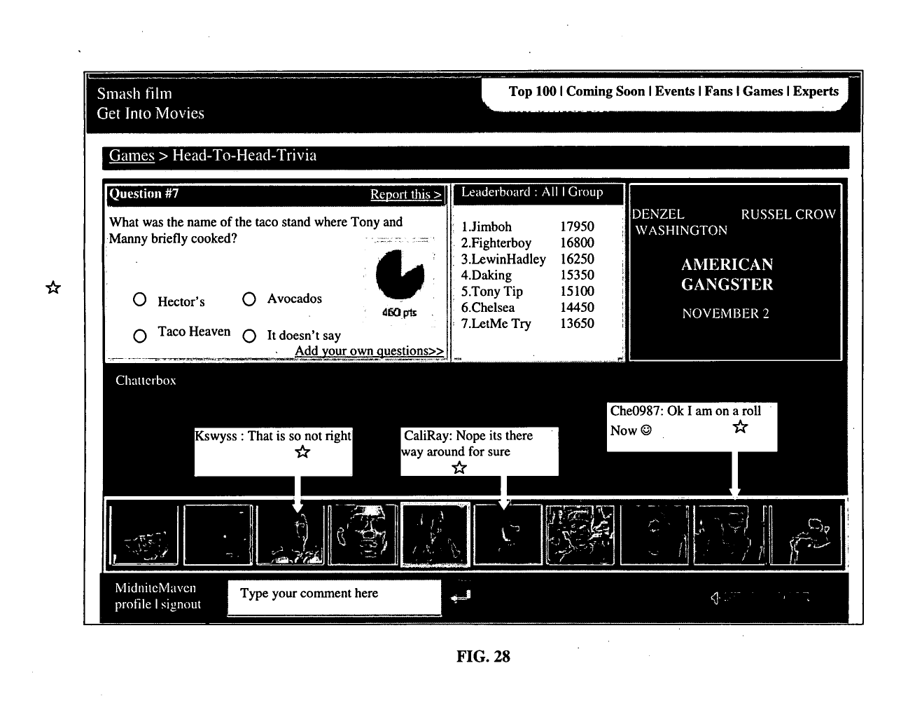

The system administrators, the platform partners, and the users may conduct polls by authoring specific questions. The polling and trivia engine 208 provides users with flexible question formats. Poll questions are time coded relative to the multimedia content. Polling logic is branched to select new questions based on the user responses to previous poll questions. The polling and trivia engine 208 may provide trivia quizzes to the users. A trivia quiz conducted among the users is exemplarily illustrated in FIG. 28.

The virtual interaction platform 201 may allow sponsored questions to be presented during the virtual sessions. Results of the polls may be analyzed by the RAA layer 206 and may contribute to determine group behavior and group dynamics. The polling and trivia engine 208 graphically displays the results of the polls. The group dynamics determined using the results may also be displayed. The group dynamics displayed may comprise patterns such as polarity, popularity, attraction, etc.

The RAA layer 206 analyzes group behavior of the users based on the virtual social gestures created by the users using the interaction modes. In the crowd visualization mode, the RAA layer 206 draws inferences on the group dynamics, for example, the mood, alignment, etc. of the users. The group dynamics may be visually represented as one or more crowd visualizations by the interaction layer 203. Crowd visualization of the users displays individual and aggregated traits of the users to present emergent group patterns, for example, polarity, popularity and attraction. Crowd visualization allows categorization of users based on their individual traits. The users are categorized on traits such as attraction, popularity, and polarity. Attraction denotes liking of a user or a user's perspective by other users. A cluster of circular images, wherein each image pictorially represents a user is used to represent the attraction between one user and the others.

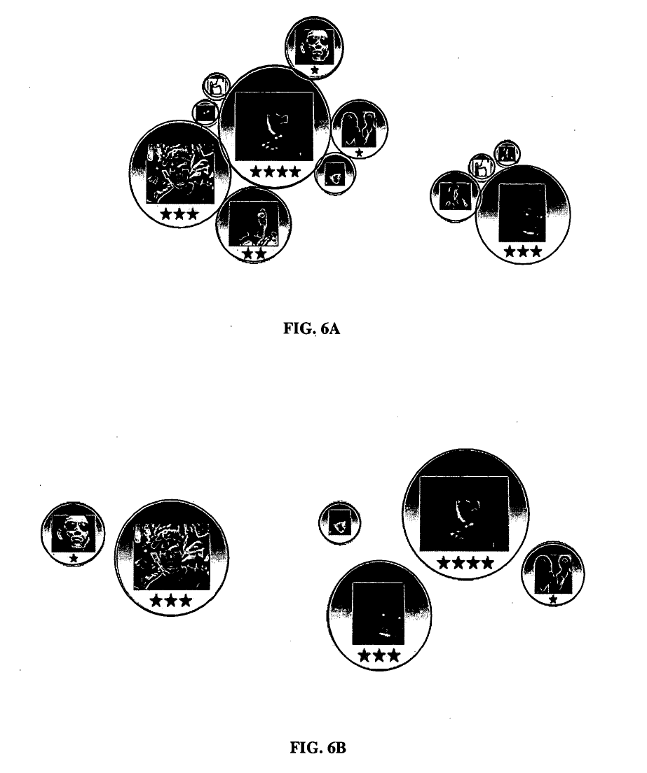

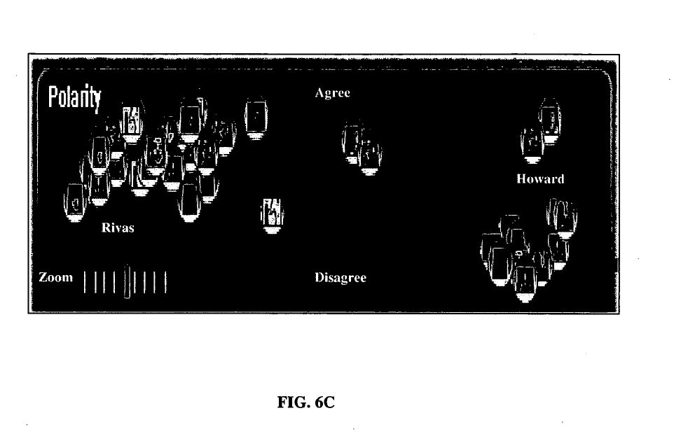

An example of crowd visualization in the virtual session is illustrated in FIG. 6A-6C. Crowd visualization provides the users rich real time feedback about the virtual session activity, including interactions between the users. By providing the feedback visually, the users may at a glance, assess and understand the group dynamics of the virtual session, increasing the sense of participation in a group experience. The crowd visualization may comprise visualization of an attraction trait, a popularity attribute, and polarity of the users.

The attraction trait in users of the virtual session is exemplarily illustrated in FIG. 6A. The attraction between the users is exemplarily represented as the clustering of circular images of the users. The size of a cluster visually denotes the number of users apparently attracted to a particular user. The attraction groups the user avatars together spatially, to show clustering of users. Attraction is based on frequency of activity, for example, linked chat or private messages and social participation rather than content.

FIG. 6B exemplarily illustrates the popularity attribute of individual users. The area of the circular image of a user implies the popularity level of the user. Relative popularity of a user in a group may be shown using size of user avatar, color, etc. Popularity may be based on physical attraction, ranking of comments and other contributions, or by the individuals express themselves within the virtual session. The larger circles represent users with higher levels of popularity.

FIG. 6C exemplarily illustrates crowd visualization through polarity. Polarity implies categorization of a user's opinions or perspectives on questions or events presented in the virtual session. Polarity shows alignment between the users and the simulcasted multimedia content, along axes such as agreement or disagreement, enthusiasm or boredom, and attraction or repulsion. During a real time virtual session, the users may be presented with ratings choices. The users' responses to the ratings choices position the user avatar within an alignment space. Multiple axes of alignment may be represented simultaneously in a two dimensional or three dimensional image that may be zoomed in and out for large numbers of users. In this way, the moods, values, likes, and orientations of even a very large group may be assessed visually and tracked against the multimedia content during the course of a real time session. Also, polarity indicates whether the group is polarizing or uniting with respect to a particular viewpoint during the virtual session.

The RAA layer 206 further provides unique, real time insight into user taste, mood, alignment, and interest level in a virtual session. The group behavior and dynamics such as polarity, popularity, attraction, etc. may be determined by the RAA layer 206 and visually presented. The RAA layer 206 allows the administrators of the virtual interaction platform 201 and the platform partners to export virtual session activity data and display analyses. The exported virtual session activity data and display analyses may be viewed in real time during the virtual session, or viewed as an archive during or after the virtual session. The RAA layer 206 archives the multimedia content and activities, including virtual session activity log, analysis of the virtual session activity, etc., for future use.

The marketing layer 204 targets in-platform advertisements to the users. The marketing layer 204 provides tools and application programmer interfaces (APIs) for in-platform advertising. Advertising agencies, third party advertisers, sponsoring partners, etc., may use the marketing layer 204 via the administrative layer 207 to target advertisements to the participants of the virtual sessions. Advertisements may comprise text, image and animated advertisements and may be drawn from an external advertisement pool that is accessed via APIs. The marketing layer 204 further enables product placement and intelligent online merchandising on the virtual interaction platform 201, managed via the administrative layer 207.

The administrative layer 207 provides tools and application programming interfaces (APIs) for managing virtual sessions, customizing the virtual interaction platform 201, branding, marketing and merchandising, authenticating the users, and managing layers of the virtual interaction platform 201. The administrative layer 207 further provides tools and APIs for managing administrative access, the multimedia content, single-sign on (SSO), and customizing the virtual interaction platform 201 and branding on the virtual interaction platform 201.

A user may create an account to access the virtual interaction platform 201, either via a platform hosted account creation mechanism or from a partner website. The account information may include user profile, electronic mail (email) address of the user, etc. An automated user's account manager may manage other account information such as a list of friends, offline messages, a repository of grabbed scenes, settings, etc. The user accounts may be stored in the platform database 213 or accessed using single sign on (SSO) through credentials of the platform partners. The user may log in to the virtual interaction platform 201 and the user is validated using the SSO.

The platform database 213 may be a primary structured query language (SQL). The platform database 213 may store the user authentication information, session schedule and information, trivia questions, platform partner and client configuration, etc. The platform database 213 also performs logging of diagnostics and session activity via the interaction server 210.

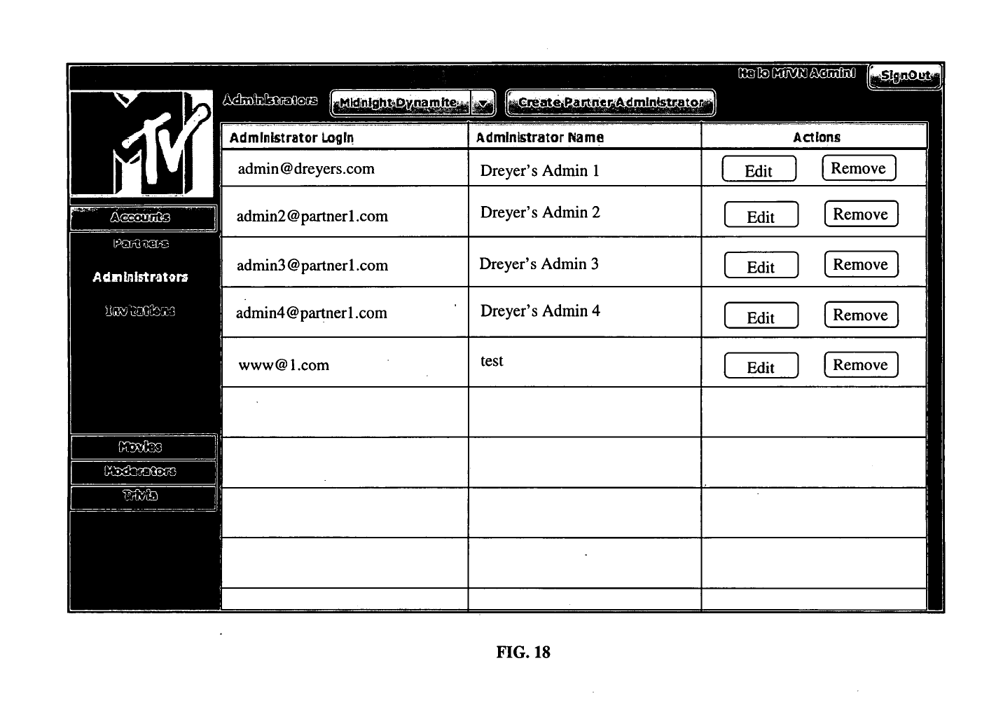

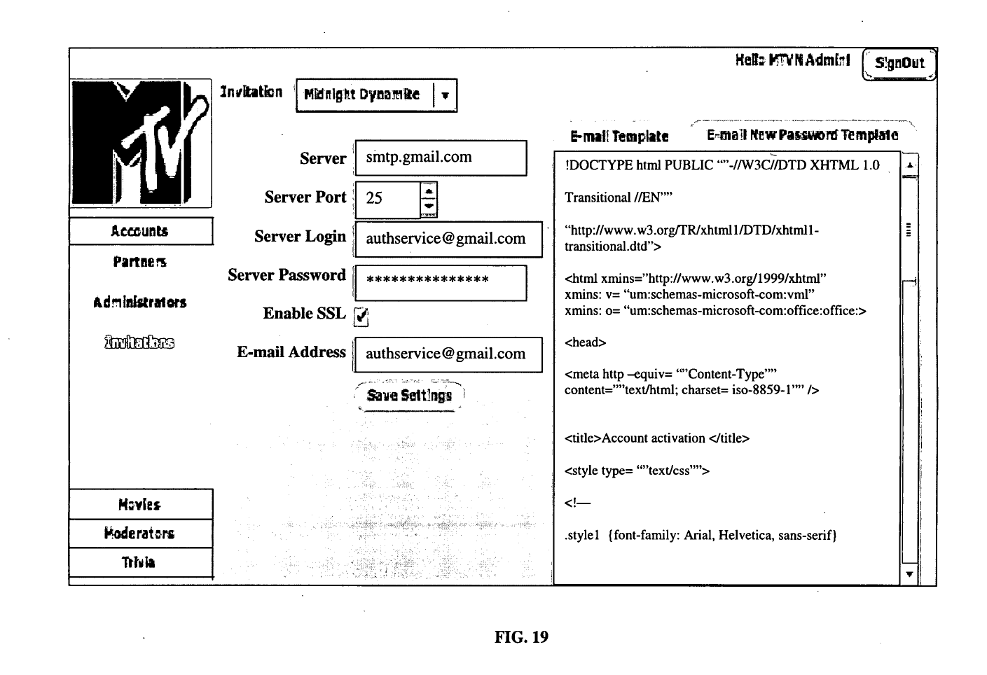

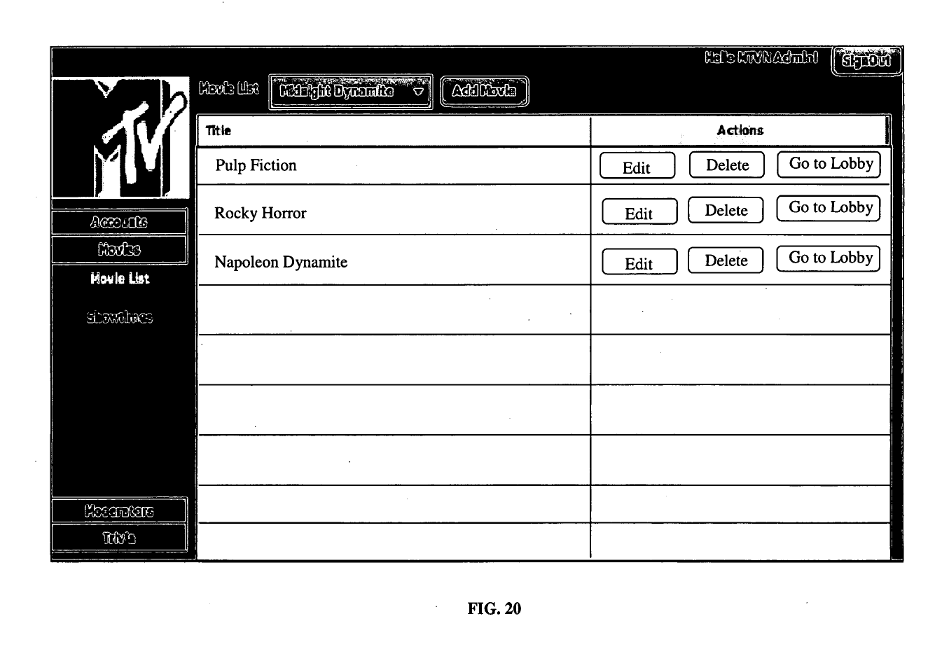

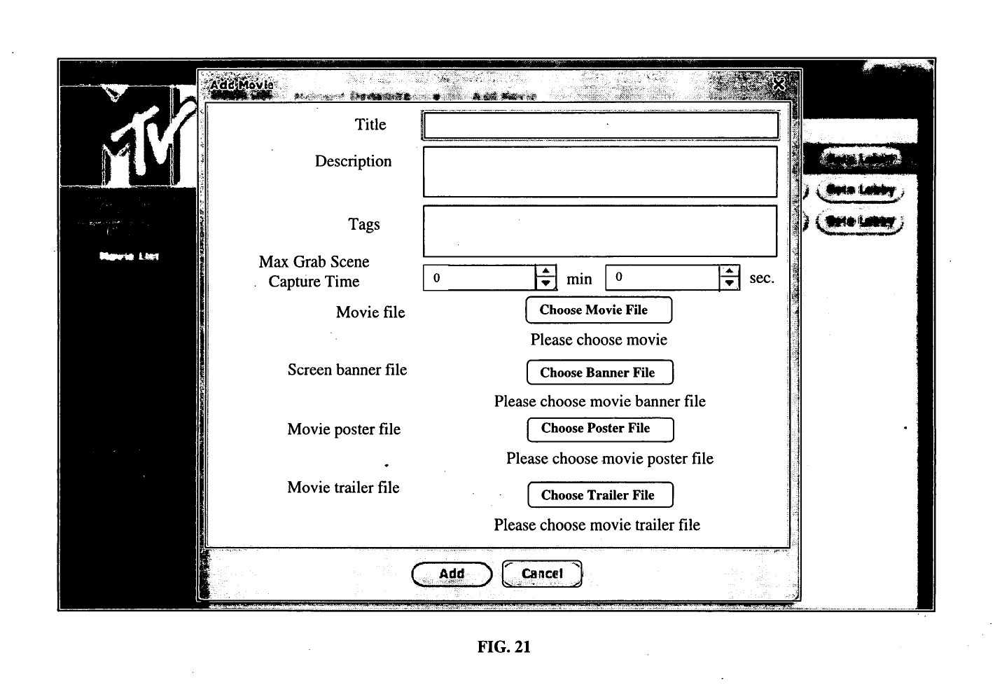

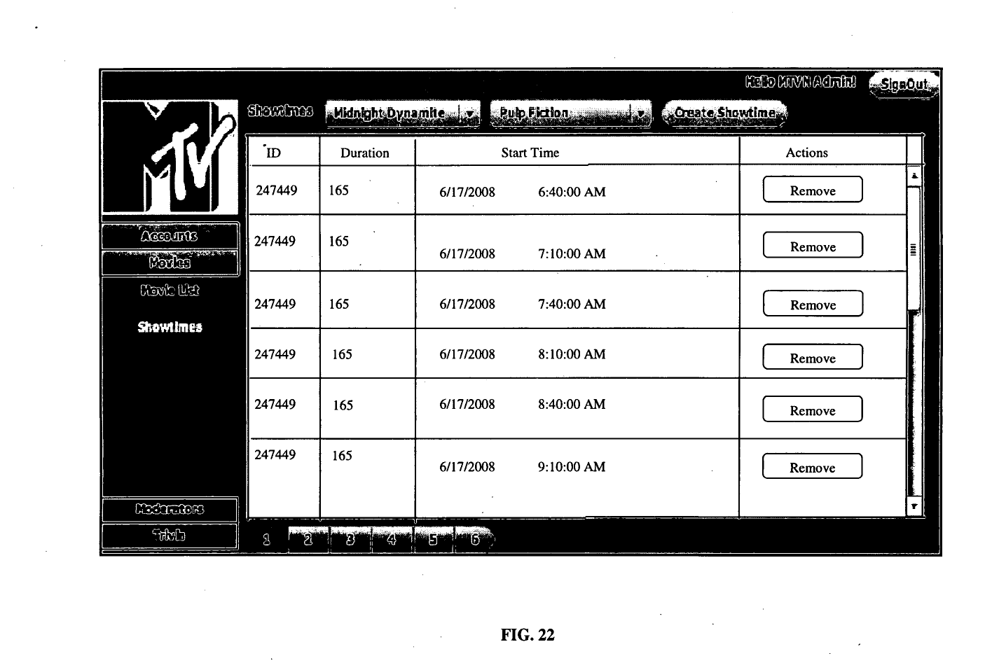

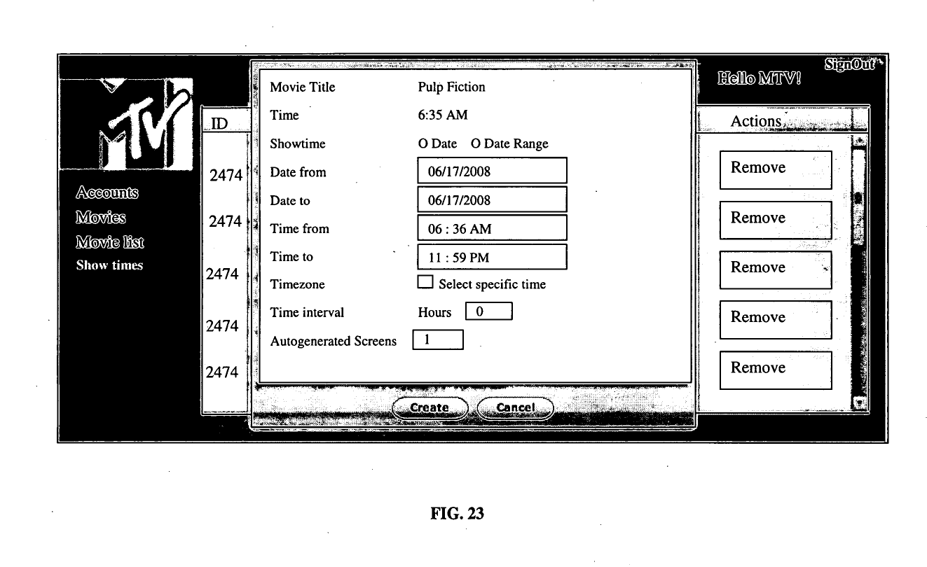

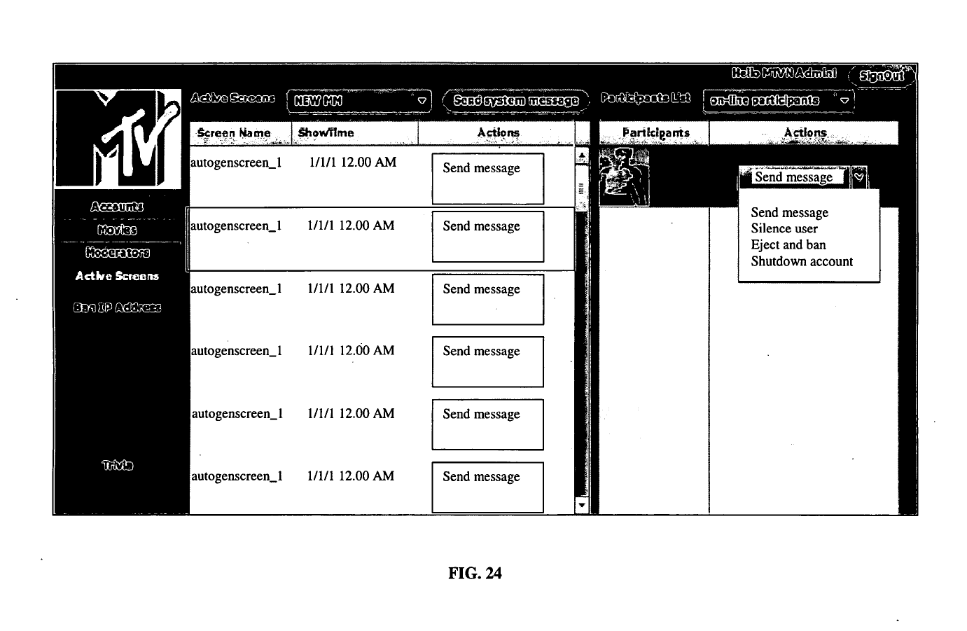

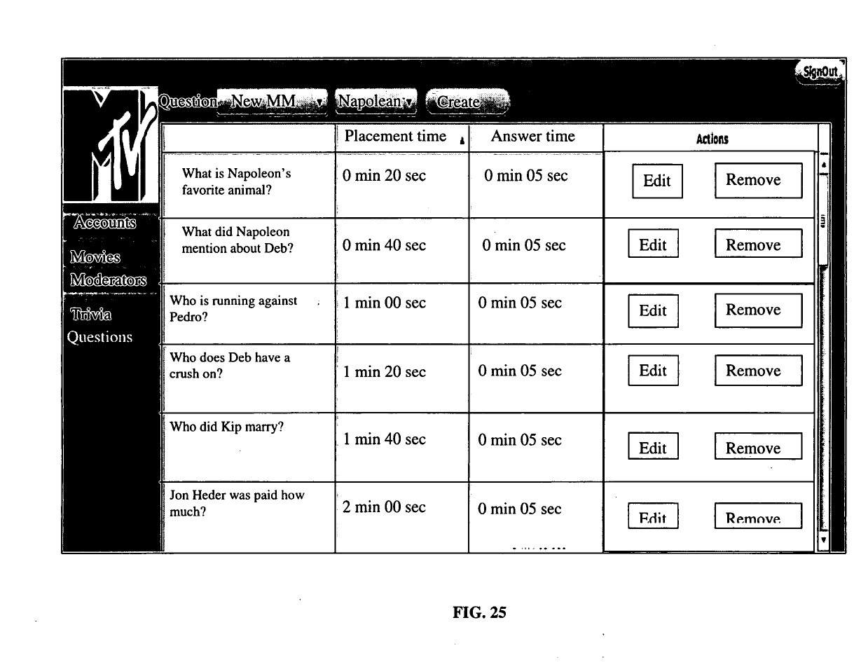

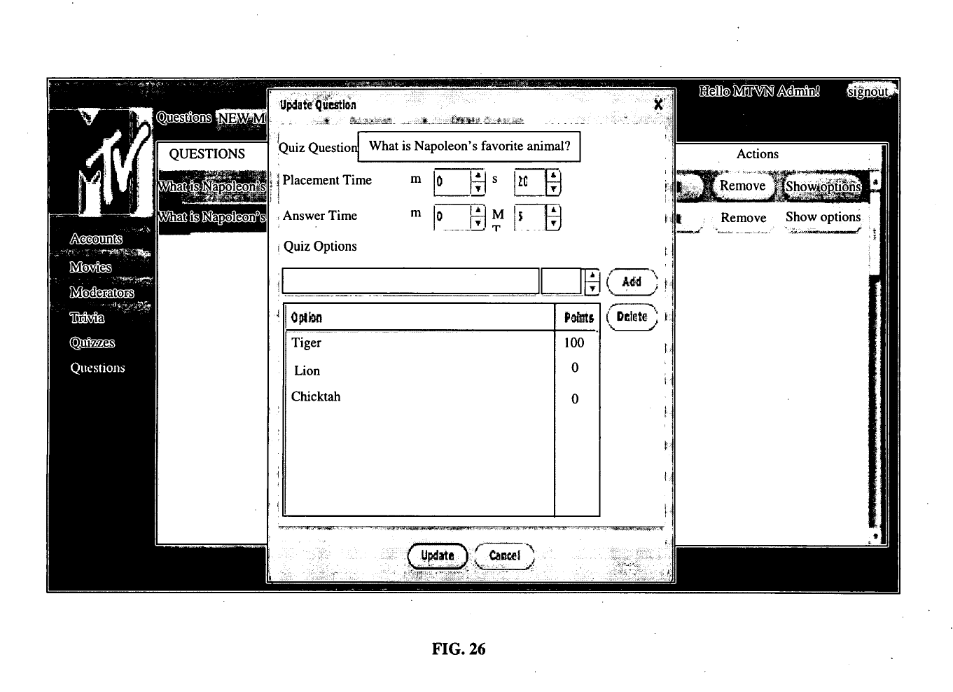

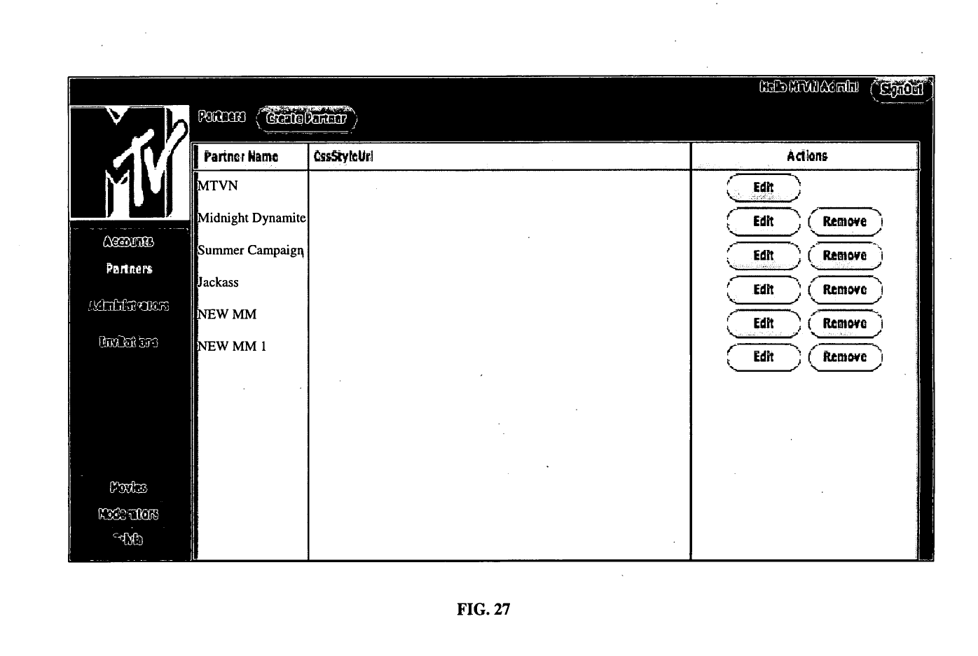

The administrative layer 207 provides an online administration console for managing the virtual interaction platform 201 and monitoring the real time online interaction. The online administration console enables administrators to quickly manage the virtual interaction platform 201, the multimedia content, and archived information, as well as monitor real time interaction. The online administration console may be easily customized to meet the needs of the users. The online administration console comprises different management interfaces for providing different functionalities to the administrators. The online administration console with the different management interfaces is exemplarily illustrated in FIGS. 18-27.

The online administration console comprises different tabs for providing the different management interfaces. The online administration console may be used to format invitations to users for a virtual session, to add, remove, or modify multimedia content, and manage virtual session screening times. The online administration console may further enable an administrator to provide real time access to the multimedia content to the users in the virtual sessions. The online administration console enables moderation of the users and making announcements, and warning, silencing, or ejecting abusive users. The online administration console further enables creation of the online polls and trivia quizzes. Questions, answers, and scoring rules may be added for the online polls and trivia quizzes. The added questions may be timed to appear at predefined points in time during the simulcasting of the multimedia content. The online administration console also enables addition of platform partners to the virtual interaction platform 201.

The administrative layer 207 utilizes an administrative server 214 for providing tools and application programming interfaces for managing the virtual sessions, customizing the virtual interaction platform 201, branding, marketing and merchandising, authenticating the users, and managing the layers of the virtual interaction platform 201. The administrative server 214 provides simple object access protocol (SOAP) services for user authentication, remote object services for applications, storage of resources, for example, extensible markup language (XML) menus for the online administration console, stylesheets, etc. and integration of advertisements into the virtual interaction platform 201.

System administration features of the administrative layer 207 enable the virtual interaction platform 201 and the platform partners to manage platform activity, configuration, and data. Platform partners may comprise various entities such as partner websites, partner SSO solutions, and other sponsoring partners. Each partner may provide solutions via a private labeled administration console with a secure login. The system administration features are completely isolated for each platform partner. The administrative layer 207 is able to create and remove platform partners, as well as access and manage the partner activities, configurations, and data. The administrative layer 207 maintains administrative accounts for the platform partners, and each platform partner creates and manages separate administrative accounts.

The administrative layer 207 makes multimedia content available for simulcasting by adding the multimedia content to the list of current multimedia content. The administrative layer 207 may select a schedule or show time for viewing the multimedia content. The administrative layer 207 may further specify show times, or may rely on users to create show times. The administrative layer 207 specifies whether user generated trivia questions are allowed during the virtual sessions.

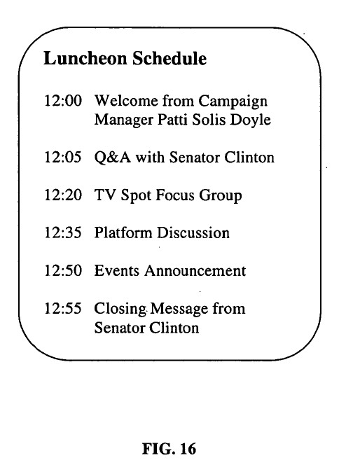

The administrative layer 207 may define and display the schedule and activities for the real time virtual session. The schedule comprises a series of defined events that may include changes to the client layout, user permissions, and the multimedia content. The events may be defined and managed by the users via a virtual session setup page or by administrators using the backend administration console. The component may be set to an automatic mode, where events occur automatically at scheduled points in time or to a manual mode where a moderator or producer drives the transition to the new event. A schedule comprising a series of defined events for the virtual session is illustrated in FIG. 16.

The administrative layer 207 may identify and list the active virtual sessions with user lists, user history, and interactions history for each of the interaction modes. The administrative layer 207 may monitor and moderate the active virtual sessions. The administrative layer 207 may moderate a user in a virtual session by sending a system message to the moderated user, to the users in a particular virtual session, or to the users in all the virtual sessions. The system message may appear on top of the other application activities until it is dismissed by the moderated user. The moderated user may be restricted from taking part in in-session interactions with the other users for a specified or open-ended amount of time. The moderated user may also be removed from the virtual session and barred from re-entry. The active virtual session being monitored and moderated may be shut down, returning the users in the virtual session to the lobby view. The moderated user's account may be shut down for a specified or open ended amount of time. The internet protocol (IP) address of the moderated user may be prevented from accessing the virtual interaction platform 201.

The administrative layer 207 may provide tools and interfaces for producing virtual sessions, including pre production setup, live production during the virtual session, and post production wrap up. For example, media may be loaded into the administrative layer 207 prior to or during the virtual session, where the media is transcoded into a displayable media format and made available to authorized producers. A production interface may be provided whereby media and other virtual session content are ordered, queued, and simulcast by the authorized producers. Production details may be specified ahead of time, or manipulated in real time during the virtual session. Further, a prompter interface may be provided to the virtual session moderators or hosts that display selected media and interactions from one or more virtual sessions, in order to provide context and information for virtual session moderation and hosting. The production functionality may be separated from the administrative functionality and the system may comprise a separate production layer.

The virtual interaction platform 201 may further comprise a social networking layer 205 for creating a social network of the users using the analyzed group behavior. The social networking layer 205 provides social networking and asynchronous community features such as user profiles and relationships. The social networking layer 205 creates a social network of the users using the analyzed group behavior. For example, users may add each other as friends. To add a friend, the user clicks the “add” link in the rollover menu presented on the GUI 203a or in the user profile. On clicking the “add” link, an “add request” dialog is displayed to the user. The user may include a personal message to the add request if needed. If an add request is received by a user during a virtual session, the add request pops up or appears on the GUI 203a. By accepting an add request, the adding user and the added user are mutually added to the friends list. The friends list is managed through the user's profile and comprises a list of friends of the user.

Users may allow only friends to view comments during a virtual session. Also, the users may optionally view only the comments posted by friends during a virtual session. The users may see the status and history of in-platform activities of friends. The users receive announcements when friends start or enter the virtual sessions. Further, the users may broadcast announcements when friends start or enter virtual sessions. Also, a user may block other users from a virtual session. The activities from the blocked users are hidden, including comments, chat messages, etc. The blocked user may be unblocked using an “unblock” link on the rollover menu.

FIG. 5 exemplarily illustrates a screen shot of the GUI 203a presented by the synchronous media layer 202 during a virtual session. A host user may host a virtual session for a particular multimedia content, for example a movie, and at a particular schedule or show time. The host user may create a new virtual session by clicking “make new screen” and selecting the desired show time and movie on the lobby view illustrated in FIG. 4. Other users may join a virtual session by selecting a virtual session or “screen” from the list of virtual sessions for any particular show time. For example, users Alice, Jane, Bob, and Harry select a particular virtual session for a particular movie and enter the virtual session hosted by a “host” user. The host user may control playback for the virtual session for a period of time, and then handoff the playback control to another user.

The GUI 203a presented during this virtual session is illustrated in FIG. 5. The user icons of the users in the virtual session are displayed on the GUI 203a. The GUI 203a further comprises display areas for interaction modes 203a such as commenting components, the “LOL” button, etc. For example user Harry may click the “LOL” button, which may cause the user's icon to move up and down animatedly representing an expression or gesture of laughter. The “grab scene” button enables the users to capture video clips during the virtual session and save the clips against user profiles. User controls and links such as “invite”, “jump to”, and “go to lobby” are illustrated in FIG. 5.

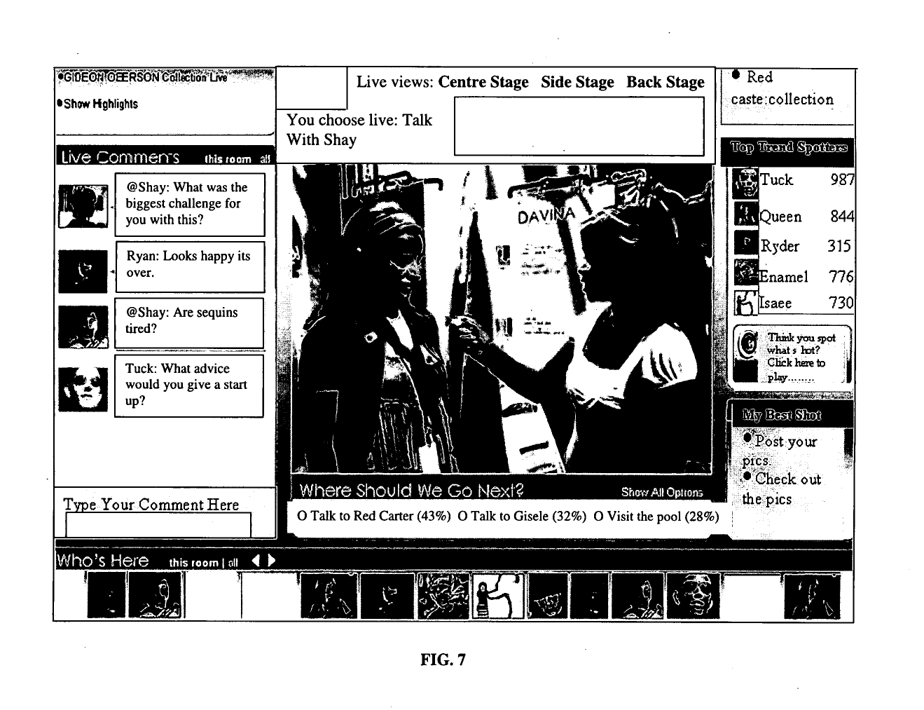

Consider an example of a live event being captured and simultaneously streamed to multiple end users. The live event may be streamed from multiple video capturing devices. The live event may be a user directed video. An exemplary screen shot of a user directed video simulcast to the users in a virtual session is illustrated in FIG. 7. The virtual interaction platform 201 allows user directed multimedia content to be streamed by feeding back suggestions of the users to the point of capture. A live camera stream may be displayed in the video area of the GUI 203a. For example, a camera and an interviewer may be directed around the event via suggestions submitted by the users. The users in a virtual session may vote via a poll on what the user directed video should cover next in the event. The polls may be conducted using the polling and trivia engine 208. The users may also pass questions to the interviewer via comments.

The virtual interaction platform 201 allows the users to virtually participate in live or recorded real world and virtual events. For example, the users may virtually participate in a real world fashion event through the virtual interaction platform 201. A specified number of cameras used in the event are user selectable. Users may, for example, select three views of a runway and one view of a user directed roving camera. As illustrated in FIG. 7, the users may vote via polls on what the users want the user directed roving camera to cover next. Comments submitted by the users may appear on the GUI 203a and subsequently fade out.

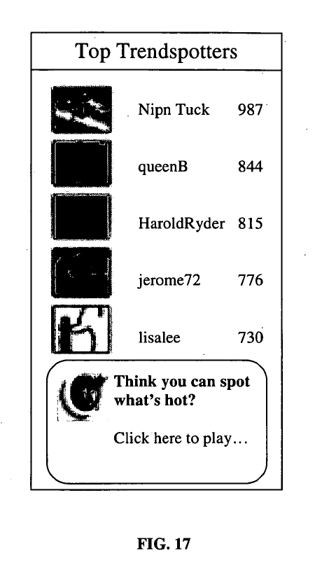

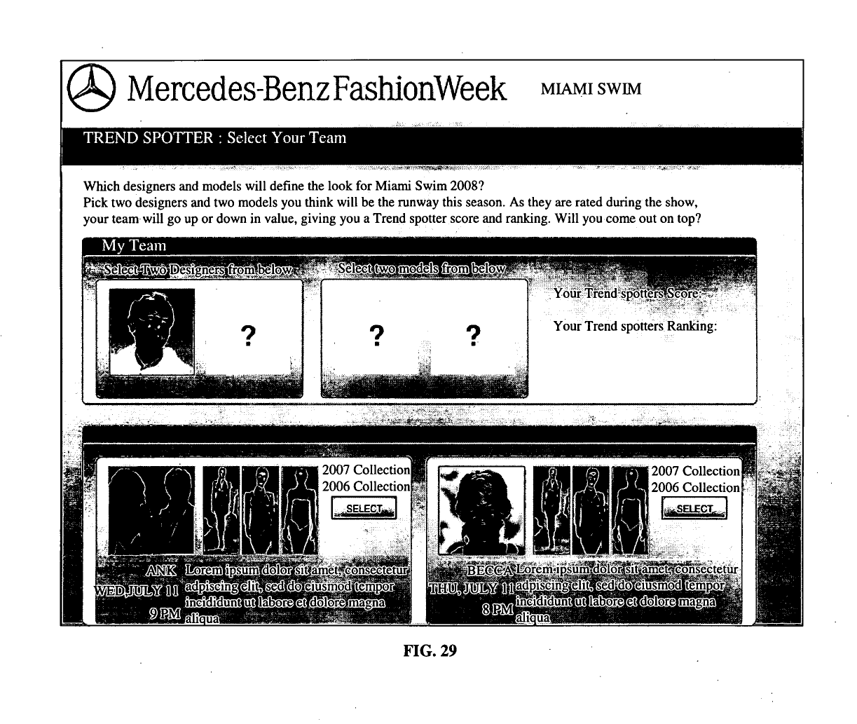

Furthermore, asynchronous features and activities may be provided to the users. Asynchronous activities of the users add depth and stickiness to user experience. For example, the users may participate in a “trend spotter” game, wherein each of the users select designers and models to be part of the user's trend spotter teams. The designers and models in the user's trend spotter teams may earn scores based on user ratings during the fashion event. The team scores may be totaled from the scores of individual designer and model picks. A list of users participating in a trend spotter game with scores is exemplarily illustrated in FIG. 17. A screen shot of a trend spotter game played by the users is exemplarily illustrated in FIG. 29.

The virtual session activities may be archived by the RAA layer 206 for future review and reuse. Response data obtained from polls, etc. may be tracked for individual users and across virtual sessions. The attention or interest level of users may be mapped to the multimedia content viewed in a virtual session. The mapping may be performed based on comments frequency, comments ratings, response frequency, etc. The timing of sponsor click throughs may also be mapped to the multimedia content.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the platform database 213, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present invention. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of real time interaction and social consumption of media by a plurality of users, comprising the steps of:
providing a virtual interaction platform for use by said users for said real time online interaction;
providing a synchronous media layer on said virtual interaction platform;
providing an interaction layer on the virtual interaction platform;
providing a reporting, archiving, and analysis layer on the virtual interaction platform for analyzing group behavior of the users;
simulcasting multimedia content for synchronous viewing by the users using said synchronous media layer;
enabling group interactions among the users by said interaction layer using a plurality of interaction modes; and
providing a marketing layer on the virtual interaction platform, wherein said marketing layer targets in-platform advertisements to the users;
whereby said simulcasted multimedia content is consumed by the users while interacting in real time using said interaction modes.

2. The computer implemented method of claim 1, wherein said step of enabling said group interactions among the users by the interaction layer using the interaction modes, comprises the steps of:
creating a plurality of virtual sessions during said simulcasting of said multimedia content on the virtual interaction platform for engaging the users in the group interactions;
creating virtual social gestures by the users using the interaction modes, wherein said virtual social gestures represent emotions, attitudes, and views of the users during the group interactions;
analyzing group behavior of the users by said reporting, archiving, and analysis layer based on said virtual social gestures; and
displaying said group behavior in a graphical format on the interaction layer.

3. The computer implemented method of claim 1, further comprising a step of providing an administrative layer on the virtual interaction platform, wherein said administrative layer provides tools and application programming interfaces for managing virtual sessions, customizing the virtual interaction platform, branding, marketing and merchandising, authenticating the users, and managing layers of the virtual interaction platform.

4. The computer implemented method of claim 3, wherein said administrative layer provides an online administration console for managing the virtual interaction platform and monitoring the real time online interaction.

5. The computer implemented method of claim 1, further comprising a step of providing a social networking layer for creating a social network of the users using said analyzed group behavior.

6. The computer implemented method of claim 1, further comprising a step of enabling the users to capture user defined portions of the simulcasted multimedia content.

7. The computer implemented method of claim 1, wherein the interaction modes are one or more of a plurality of configurable modalities, wherein said configurable modalities comprise chat messages, bubble messages, comment components, user icons, graphical user interface widgets, interactable objects, graphical objects and animations.

8. The computer implemented method of claim 1, wherein said step of enabling said group interactions comprises conducting real time polls among the users.

9. A computer implemented system for real time online interaction and social consumption of media by a plurality of users, comprising:
a virtual interaction platform for use by said users for said real time online interaction, comprising:
a synchronous media layer for simulcasting multimedia content for synchronous viewing by the users;
an interaction layer comprising a plurality of interaction modes for enabling the users to engage in group interactions, wherein said interaction modes are one or more of a plurality of configurable modalities, wherein said configurable modalities comprise chat messages, bubble messages, comment components, user icons, graphical user interface widgets, and interactable objects;
a reporting, archiving, and analysis layer for analyzing group behavior of the users based on virtual social gestures created by the users using the interaction modes; and
a marketing layer for targeting in-platform advertisements to the users.

10. The computer implemented system of claim 9, wherein said interaction layer performs the steps of:
creating a plurality of virtual sessions during said simulcasting of said multimedia content on said virtual interaction platform for engaging the users in said group interactions;
creating said virtual social gestures by the users using the interaction modes, wherein the virtual social gestures represent emotions, attitudes, and views of the users during the group interactions; and
displaying group behavior analyzed by said reporting, archiving, and analysis layer based on said virtual social gestures, in a graphical format.

11. The computer implemented system of claim 9, wherein said virtual interaction platform further comprises an administrative layer for providing tools and application programming interfaces for managing virtual sessions, customizing said virtual interaction platform, branding, marketing and merchandising, authenticating the users, and managing layers of the virtual interaction platform.

12. The computer implemented system of claim 11, wherein said administrative layer provides an online administration console for managing the virtual interaction platform and monitoring the real time online interaction.

13. The computer implemented system of claim 11, wherein said administrative layer utilizes an administrative server for providing said tools and said application programming interfaces.

14. The computer implemented system of claim 9, wherein said interaction layer utilizes an interaction server for enabling the users to engage in said group interactions.

15. The computer implemented system of claim 9, wherein said synchronous media layer utilizes a streaming server for simulcasting said multimedia content for synchronous viewing by the users.

16. The computer implemented system of claim 9, further comprising a multimedia capturing server for enabling the users to capture user defined portions of said simulcasted multimedia content.

17. The computer implemented system of claim 9, further comprising a platform database for storing user authentication information, virtual session schedules, trivia questions, and platform partner configuration.

18. The computer implemented system of claim 9, wherein said virtual interaction platform further comprises a social networking layer for creating a social network of the users using said analyzed group behavior.

19. The computer implemented system of claim 9, wherein said virtual interaction platform further comprises a polling and trivia engine for conducting real time polls among the users.

20. The computer implemented system of claim 9, wherein said interaction layer comprises a graphical user interface for graphically displaying said simulcasted multimedia content, the interaction modes, in-platform advertisements, user profiles, and group dynamics.

21. A computer program product comprising computer executable instructions embodied in a computer-readable medium, wherein said computer program product comprises:
a first computer parsable program code for providing a virtual interaction platform for use by a plurality of users for real time online interaction;
a second computer parsable program code for providing a synchronous media layer on said virtual interaction platform;
a third computer parsable program code for providing an interaction layer on the virtual interaction platform;
a fourth computer parsable program code for providing a reporting, archiving, and analysis layer on the virtual interaction platform;
a fifth computer parsable program code for simulcasting multimedia content for synchronous viewing by the users using said synchronous media layer;
a sixth computer parsable program code for enabling group interactions among the users by said interaction layer using a plurality of interaction modes; and
a seventh computer parsable program code for providing a marketing layer on the virtual interaction platform, wherein said marketing layer targets in-platform advertisements to the users.
